(19) United States
(12) Patent Application Publication
(10) Pub. No.: US 2016/0154160 A1
(43) Pub. Date: Jun. 2, 2016

(54) METHOD FOR MANUFACTURING ORIENTED-FIBER COMPOSITE MATERIAL, ORIENTED-FIBER COMPOSITE MATERIAL MANUFACTURED THEREBY, REFLECTIVE POLARIZING LIGHT FILM COMPRISING ORIENTED-FIBER COMPOSITE MATERIAL AND METHOD FOR MANUFACTURING REFLECTIVE POLARIZING LIGHT FILM

(71) Applicant: KOREA INSTITUTE OF INDUSTRIAL TECHNOLOGY, Chungcheongnam-do (KR)

(72) Inventors: Dae Young Lim, Yongin-si (KR); Won Young Jeong, Gunpo-si (KR); Tae Hyung Kim, Ansan-si (KR)

(73) Assignee: Korea Institute of Industrial Technology, Cheonan-si (KR)

(21) Appl. No.: 14/903,690

(22) PCT Filed: May 30, 2014
(86) PCT No.: PCT/KR2014/004847

§ 371 Date: Jan. 8, 2016

(30) Foreign Application Priority Data
Jul. 10, 2013 (KR) 10-2013-0081209
Dec. 20, 2013 (KR) 10-2013-0160209

(51) Int. Cl. G02B 5/30; B29D 7/01; B29C 70/14; G02F 1/13363; G02F 1/1335

(52) U.S. Cl. CPC G02B 5/3083; G02F 1/13363; G02F 1/133504; B29C 70/14; B29D 7/01; G02F 2001/133507

(57) ABSTRACT

The present invention relates to a method for manufacturing in-situ oriented-fiber composite material, the method simultaneously extruding, using thermoplastic members, matrix ingredients and fiber ingredients, and passing same through a nozzle of a set cross-sectional shape, weight and fill ratio of the fiber ingredient, thereby aligning the fiber ingredients within the matrix in one direction one single continuous step, and thus, by means of the production method, the process is shortened, the thinning of the thickness of the oriented-fiber composite material is attained, and particularly, filling, distribution and reinforcement of the fiber within the matrix can be effectively controlled and a high density of the fiber can be attained. Furthermore, the present invention provides an element exhibiting superbly effective reflective polarization by controlling so that the lengthwise refractive index of the matrix is lower than the lengthwise refractive index of the fiber ingredients in the oriented-fiber composite material, thus the element can replace conventional reflective polarizing light film and can be effectively used as an optical element in other fields.

### CROSS REFERENCE TO RELATED APPLICATIONS

This application is a 371 National State application of International Application No. PCT/KR2014/004847 filed on May 30, 2014, which claims priority of Korean Serial Number 10-2013-0081209 filed on Jul. 10, 2013 and Korean Serial Number 10-2013-0160209 filed Dec. 20, 2013, all of which are incorporated herein by reference in their entireties.

### BACKGROUND OF THE INVENTION

1. Field of the Invention

The present invention relates to a method for manufacturing a fiber-oriented composite material, a fiber-oriented composite material made using the method, a reflective composite sheet made of the fiber-oriented composite material, and a method for manufacturing the reflective composite sheet, and more particularly, to a method for manufacturing a fiber-oriented composite material wherein a matrix component and a fiber component made of thermoplastic materials are at the same time extruded and then pass through a nozzle predetermined to have a cross-sectional shape, fiber thickness and filling ratio of fibers, so that the fibers are arranged in a matrix in one direction in-situ manner, to a fiber-oriented composite material made using the method so that the fibers are arranged in-situ in a matrix in one direction, to a reflective composite sheet made of the fiber-oriented composite material, and to a method for manufacturing the reflective composite sheet.

2. Description of the Prior Art

Studies on a method for embedding fibers in a polymer matrix in such a manner as to be arranged at high quality in the matrix have been continuously made, and particularly, through the control in the orientation of the fibers distributed in the matrix, the application fields of the method have been extended up to fiber reinforcement fields as well as recently developed optical industrial fields using the optical properties of fibers.

As application fields wherein excellent physical properties of fiber-oriented composite materials are utilized are expanded, accordingly, studies on the improvements of the physical properties of the fiber-oriented composite materials or the simplification of the process for making the fiber-oriented composite materials have been generally made.

According to conventional fiber-oriented composite materials, fibers are arranged in a matrix in one direction and next, they are attached to the matrix by means of bonding, and otherwise, laminates on which a textile-reinforced material is impregnated are laid on each other.

In case of the composite material obtained by means of bonding, however, the state of bonding between layers may be bad, and the fiber making process and the composite process should be individually conducted, thus making the process complicated.

According to the composite material obtained by means of laminates on which a textile-reinforced material is impregnated, on the other hand, if the textile-reinforced material having fiber bundles located in warp thread direction and fiber bundles located in weft thread direction is impregnated in a matrix resin and then hardened, matrix resin rich areas occur between the surface of the fiber bundles located in the warp thread direction and the surface of the fiber bundles located in the weft thread direction, thus making the thickness between the laminates undesirably increased.

So as to increase the strength between the layers in the fiber-oriented composite material, accordingly, there are provided methods for stitching reinforcement fibers in a thickness direction of the laminates or for making a three-dimensionally shaped fiber preform and impregnating a resin in the preform. However, the conventional methods require high-priced equipment for precise fiber arrangements, which is not achieved with the existing equipment. Through the conventional methods, further, it is difficult to obtain high density in the fibers arranged in a thickness direction.

One of the conventional fiber-oriented composite materials is disclosed in Korean Patent Application No. 2010-70989 wherein the fiber-oriented composite material includes an inside textile layer woven with the fiber bundles located in warp thread direction and the fiber bundles located in weft thread direction and a fine fiber layer disposed on at least one surface of both surfaces of the inside textile layer, wherein the fine fiber layer has fine fibers arranged three-dimensionally.

However, the fine fiber layer is coupled to the inside textile layer by means of a binder resin or niddle punching, thus undesirably requiring multiple processes.

The fiber-oriented composite material designed to arrange the fibers in the matrix at high quality can be extended in application fields thereof through the improvement of the strength and elasticity and the optical birefringence of the fiber component.

For example, a display panel is widely used for display devices, such as, electronic calculators, electronic watches, automobile navigations, office automation instruments, cellular phones, laptop computers, telecommunication terminals and so on.

A liquid crystal device among the display devices does not emit light therefrom, and accordingly, it needs a separate light source like a backlight unit. The backlight unit includes a lamp, a reflection panel, a light guide panel, a diffuser plate, a prism film and a brightness enhancement film, and a liquid crystal display panel is located above the backlight unit.

The brightness enhancement film of the backlight unit serves to reduce the loss of light emitted from the prism film to increase the brightness of the liquid crystal device, and a representative example of the brightness enhancement film is dual brightness enhancement film (which is referred to as ‘DBEF’). That is, if unpolarized light is incident on the DBEF, one light is transmitted, and the other light is reflected, so that the quantity of light in the transmission direction is increased through the recycling of light.

The DBEF is a thin reflective composite sheet that serves to prevent transverse waves of light from being absorbed into a polarizer located on the underside of the liquid crystal display panel to enhance the brightness of the liquid crystal device.

The DBEF has a structure in which a plurality of polymer films is laminated and each laminate has an optical thickness of ¼ of a specific wavelength λ, with respect to light having the specific wavelength λ in a visible light range.

So as to obtain the brightness enhancement effects through the transmission and reflection in the wide wavelength region of the visible light, accordingly, total 400 to 800-layer polymer films should be laminated on each other. Therefore, the DBEF has the technical difficulties in the control of the thickness and the lamination of hundreds of polymer films.

Referring to a reflective composite sheet disclosed in Korean Patent Registration No. 432457, it can be checked that hundreds of optical layers are laminated on each other.

Further, the liquid crystal device displays video through the application of electric field and the polarized light to a specific direction in the light transmitted from a light source. Accordingly, the liquid crystal display is generally configured wherein a liquid and electrode matrix is disposed between a pair of light absorbing polarizers.

However, the polarizers of the conventional liquid crystal display transmit the polarized light (which is referred to as ‘P-polarized light’) in any one direction of the light transmitted from a light source and absorb and remove the polarized light (which is referred to as ‘S-polarized light’) in the other direction thereof, so that the brightness of the display device becomes drastically low due to the loss of light and the power consumption is increased.

So as to solve the above-mentioned problems, Korean Patent Registration No. 432457 further discloses a brightness enhancement device having the reflective composite sheet disposed between an optical cavity and an liquid crystal assembly.

According to the polarized light separation principle of the brightness enhancement device, the P-polarized light of the light moving from the optical cavity to the liquid crystal assembly is transmitted to the liquid crystal assembly through the reflective composite sheet, and the S-polarized light is reflected on the optical cavity from the reflective composite sheet, then reflected on the diffusion and reflection surface of the optical cavity in a state of being random in the polarizing direction of the light, and next transmitted to the reflective composite sheet again, so that the S-polarized light is converted into the P-polarized light capable of transmitting the polarizer of the crystal liquid assembly, and the converted P-polarized light passes through the reflective composite sheet and is transmitted to the crystal liquid assembly.

Through the above technology, the loss of light generated from the light source and the power consumption can be all reduced, but according to the reflective composite sheet of the conventional brightness enhancement device, flat plate-shaped isotropic optical layer and anisotropic optical layer having different refractive indices from each other are alternately laminated, and the laminated layers are elongated to have the optical thickness and refractive indices optimum to the selective reflection and transmission of the incident polarized light, thus making the manufacturing process of the reflective composite sheet more complicated.

Therefore, the present inventors have made various studies to solve the above problems and as a result, they have found a method for manufacturing a fiber-oriented composite material wherein a matrix component and a fiber component made of thermoplastic materials are at the same time extruded and then pass through a nozzle predetermined to have a fiber cross-sectional shape, fiber thickness and filling ratio of fibers, so that the fibers are arranged in a matrix in one direction in-situ manner, thus reducing the number of processes for making the fiber-oriented composite material, achieving the thinning of thickness, and controlling the filling, distribution or reinforcement of the fibers in the matrix. Further, the present inventors have found a reflective composite sheet having excellent reflection polarizing efficiencies through the control of a specific refractive index of the manufactured fiber-oriented composite material.

### BRIEF SUMMARY OF THE INVENTION

Accordingly, the present invention has been made in view of the above-mentioned problems occurring in the prior art, and it is an object of the present invention to provide a method for manufacturing a fiber-oriented composite material that is capable of in-situ arranging fibers in a matrix, so that the fibers are efficiently filled, distributed or reinforced in the matrix.

It is another object of the present invention to provide a fiber-oriented composite material that is capable of allowing fibers in a matrix to be arranged in one direction, thus reinforcing the strength and elasticity thereof and obtaining optical birefringence through the fibers.

It is other object of the present invention to provide a reflective composite sheet made of the fiber-oriented composite material and a method for manufacturing the reflective composite sheet.

To accomplish the above-mentioned objects, according to a first aspect of the present invention, there is provided a method for manufacturing a fiber-oriented composite material including the steps of: a) feeding a matrix component and a fiber component into each extruder, at the same time; b) passing the melt of the supplied matrix component and fiber component through a nozzle predetermined to have a fiber cross-sectional shape, fiber thickness and filling ratio of fibers, and distributing and arranging the fibers in a matrix in such desired shape and arrangement; and c) molding the fibers distributed and arranged in the matrix to a sheet so that the fibers are aligned in the matrix in one direction in-situ manner.

According to the present invention, preferably, a difference of melting temperature between the matrix component and the fiber component is greater than 20° C.

According to the present invention, preferably, a surface tension difference between the matrix component and the fiber component is greater than 20 dyne/m.

According to the present invention, preferably, at the step (a) the matrix component and the fiber component are supplied at the weight ratio of 1:9 to 9:1.

According to the present invention, preferably, at the step (b) the fibers in the matrix have the cross-sectional shapes selected from the group consisting of a circle, a polygon and a combination thereof.

According to the present invention, preferably, at the step (c) the molding is conducted by any one selected from the group consisting of inflation circular die extrusion, T-die extrusion, slit-die extrusion and co-extrusion.

According to the present invention, preferably, the fibers in the matrix are fixedly arranged in the determined cross-sectional shape and position through the die, and at this time, the injection angle of the die is in the range of 60 to 120°.

According to the present invention, preferably, the method further includes the step of elongating the sheet after the step (c).

To accomplish the above-mentioned objects, according to a second aspect of the present invention, there is provided a method for manufacturing a fiber-oriented composite material.

In more detail, there is provided a fiber-oriented composite material including fibers embedded within a matrix aligned continuously in the longitudinal direction thereof and arranged discontinuously in the perpendicular direction to the longitudinal direction thereof.

According to the present invention, preferably, if a surface tension difference between the matrix component and the fiber component is greater than 20 dyne/m, the fibers embedded within the matrix have the cross-sectional shapes selected from the group consisting of a circle, a polygon and a combination thereof.

According to the present invention, preferably, if a surface tension difference between the matrix component and the fiber component is less than 20 dyne/m, the fibers embedded within the matrix have the cross-sectional shapes selected from the group consisting of a circle, a polygon and a combination thereof in such a manner as to be extended in one axis direction thereof.

To accomplish the above-mentioned objects, according to a third aspect of the present invention, there is provided a reflective composite sheet made of a fiber-oriented composite material wherein fibers in a matrix are arranged in-situ, while the refractive index of the matrix in the longitudinal direction thereof is being greater than the refractive index of the fibers in the longitudinal direction thereof.

According to the present invention, preferably, the refractive index in the vertical direction to the longitudinal direction of the fibers is greater than or equal to the refractive index in the vertical direction of the matrix.

According to the present invention, preferably, the fiber-oriented composite material has a multi-layered structure having the fibers arranged repeatedly in the matrix in such a manner as to have high-low-high refractive indices in the longitudinal direction thereof.

According to the present invention, preferably, a difference between the refractive index in the longitudinal direction of the matrix and the refractive index in the longitudinal direction of the fibers is greater than 0.01.

According to the present invention, preferably, the fibers in the matrix have the cross-sectional shape selected from the group consisting of a circle including a sphere or an oval, a polygon including a triangle or a square and a combination thereof.

According to the present invention, preferably, the fibers in the matrix are distributed and arranged in the range of 10 to 90 weight %.

To accomplish the above-mentioned objects, according to a fourth aspect of the present invention, there is provided a method for manufacturing a reflective composite sheet made of a fiber-oriented composite material, the method including the steps of: a) extruding a matrix component and a fiber component through a bi-composite spinneret, at the same time; b) distributing and arranging fibers in a matrix; and c) molding the extrudate of the fibers distributed and arranged in the matrix to a sheet, wherein the reflective composite sheet is made of the fiber-oriented composite material wherein through a take-up process at the step (c), the refractive index of the fibers in the longitudinal direction thereof is less than the refractive index of the matrix in the longitudinal direction thereof, and the refractive index in the vertical direction to the longitudinal direction of the fibers is greater than or equal to the refractive index in the vertical direction of the matrix, thus inducing polarized light.

According to the present invention, preferably, the fiber-oriented composite material has a multi-layered structure having the fibers arranged repeatedly in the matrix in such a manner as to have high-low-high refractive indices in the longitudinal direction thereof.

According to the present invention, preferably, a difference between the refractive index in the longitudinal direction of the matrix and the refractive index in the longitudinal direction of the fibers is greater than 0.01.

According to the present invention, preferably, the matrix component and the fiber component are at the same time extruded at the weight ratio of 1:9 to 9:1.

According to the present invention, preferably, the method further includes the step of elongating the sheet after the step (c), so as to control the refractive indices between the components of the fiber-oriented composite material.

To accomplish the above-mentioned objects, according to a fifth aspect of the present invention, there is provided a backlight unit for a liquid crystal display using the reflective composite sheet.

According to the present invention, there is provided the method for manufacturing the fiber-oriented composite material wherein the matrix component and the fiber component, which are made of the thermoplastic materials, are at the same time extruded and then pass through the nozzle predetermined to have a fiber cross-sectional shape, fiber thickness and filling ratio of the fibers, so that the fibers are arranged in the matrix in one direction in-situ manner, while the cross-sectional shape, fiber thickness and filling ratio of the fibers in the matrix are being controlled. Through the manufacturing method of the in-situ process, the composite material is obtained, thus reducing the number of processes, making the thicknesses of the fibers and the matrix to be thin, effectively controlling the filling, distribution or reinforcement of the fibers in the matrix, and achieving the high degree of density of fibers in the matrix.

Accordingly, the fiber-oriented composite material made using the method is configured wherein the fibers are arranged in the matrix in one direction in-situ manner. In more detail, the fibers are arranged continuously in the matrix in the longitudinal direction thereof, while being arranged discontinuously in the perpendicular direction to the longitudinal direction, thus reinforcing the strength and elasticity thereof and expecting the extension of the applicable fields according to the optical birefringence of the fibers.

Furthermore, the present invention provides the reflective composite sheet made of the fiber-oriented composite material to which polarized light is induced, wherein high reflection is induced to the longitudinal direction of the fibers and low reflection is induced to the vertical direction to the longitudinal direction of the fibers, so that horizontally polarized light is reflected, and the other vertically polarized light is transmitted.

Additionally, the present invention provides the method for manufacturing the reflective composite sheet wherein the fibers are arranged in the matrix in one direction, while the cross-sectional shape, fiber thickness and filling ratio of the fibers in the matrix are being controlled, so that specific refractive index conditions are controlled in process, thus providing excellent reflective polarization.

Furthermore, the present invention provides the backlight unit for a liquid crystal display that is improved in physical properties, through the reflective composite sheet having excellent reflective polarization.

### BRIEF DESCRIPTION OF THE DRAWINGS

FIG. 1 is a diagram view showing a method for manufacturing a fiber-oriented composite material according to the present invention.

FIG. 2 is a perspective view showing the cross-sectional shapes of fibers obtained through a nozzle in the method according to the present invention.

FIG. 3 is cross-sectional view showing examples of the cross-sectional shapes of fibers designed through the nozzle in the method according to the present invention.

FIG. 4 is a photograph showing the cross-section of a fiber-oriented composite material manufactured according to Example 4.

FIG. 5 is photograph showing the cross-section and surface of a fiber-oriented composite material of a reflective composite sheet manufactured according to Example 6.

FIG. 6 is graph showing reflectance measurement result of the reflective composite sheet manufactured according to Example 6 to 8.

FIG. 7 is a photograph showing the cross-section of a fiber-oriented composite material of a reflective composite sheet manufactured according to Example 9.

FIG. 8 is graph showing reflectance measurement result of the reflective composite sheet made of a multi-layer fiber-oriented composite material manufactured according to Example 9, which is observed with respect to incident light of 0° and 90° and the directions of long and short axes.

FIG. 9 is a graph showing reflectance measurement result of the reflective composite sheet made of a multi-layer fiber-oriented composite material manufactured according to Example 10, with respect to directions of long and short axes.

FIG. 10 is a graph showing the simulation estimation result of optimum reflectance of the reflective composite sheet made of the fiber-oriented composite material.

FIG. 11 is a graph showing the simulation estimation result of optimum reflectance of the reflective composite sheet made of the multi-layer fiber-oriented composite material.

FIG. 12 is a graph showing the simulation estimation result of reflectance of the reflective composite sheet made of the fiber-oriented composite material wherein a refractive index difference between the longitudinal direction of the fibers and the longitudinal direction of the matrix is set to 0.03.

FIG. 13 is a graph showing the simulation estimation result of reflectance of the reflective composite sheet made of the fiber-oriented composite material wherein a refractive index difference between the longitudinal direction of the fibers and the longitudinal direction of the matrix is set to 0.01.

### DETAILED DESCRIPTION OF THE PREFERRED EMBODIMENTS

The present invention relates to a method for manufacturing a fiber-oriented composite material including the steps of: feeding a matrix component and a fiber component into each extruder, at the same time; passing the melt of the supplied matrix component and fiber component through a nozzle predetermined to have a fiber cross-sectional shape, fiber thickness and filling ratio of fibers, and distributing and arranging the fibers in a matrix in such a manner as to have desired fiber cross-sectional shape and arrangement; and molding the fibers distributed and arranged in the matrix to a sheet so that the fibers are arranged in the matrix in one direction in-situ manner.

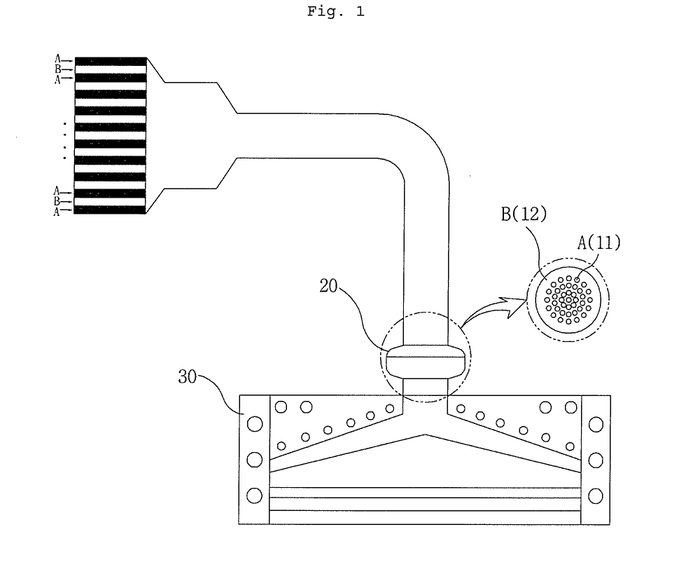

FIG. 1 is a diagram view showing a method for manufacturing a fiber-oriented composite material according to the present invention.

In more detail, the method for manufacturing a fiber-oriented composite material according to the present invention includes the first step of alternately arranging a matrix component and a fiber component (A and B components) and feeding them at the same time; the second step of passing the melt of the supplied matrix component and fiber component through a nozzle predetermined to have a cross-sectional shape, fiber thickness and filling ratio of fibers, and distributing and arranging the fibers in a matrix in such a manner as to have desired fiber cross-sectional shape and arrangement; and the third step of molding the extrudate of the fibers distributed and arranged in the matrix to a sheet.

In the first step, first, the matrix component and the fiber component are at the same time feeding into each extruder. If the A component is the matrix component, the B component is the fiber component, and if the two components are alternately arranged and supplied, their position may be changed.

In the first step of the method according to the present invention, the number of fibers and the ratio of fibers occupied in the matrix can be controlled. That is, the number of fibers is theoretically in the range of 1 to infinity. In more detail, the number of fibers is in the range of thousands of fibers to millions or more of fibers combined by the thousands of fibers, which are conducted in a general laboratory. At this time, the number of fibers introduced is an important factor in determining the ratio of fibers occupied in the matrix and the size of the fibers.

In the first step of the method according to the present invention, further, it is important to choose the materials of the matrix component and the fiber component so as to at the same time mold the matrix component and the fiber component made of the materials to be melted.

Desirably, a melting temperature difference between the matrix component and the fiber component is greater than 20° C. At this time, the fiber component is made of a crystalline material having a high melting temperature of greater than 250° C., which may be selected from known thermoplastic polymers.

Contrarily, the matrix component is made of a crystalline or amorphous material having a lower melting temperature than the fiber component, which may be selected from known thermoplastic polymers or thermosetting polymers.

According to the present invention, desirably, the fiber component is selected from the group consisting of polyethylene naphthalate PEN, polycyclohexane dimethylterephthalate PCT, or polyethylene therephthalate PET, and the matrix component is selected from the group consisting of poly-4-methylene pentene PMP, polycarbonate PC, polyethylene therephthalate PET copolymer, or polycyclohexane dimethylterephthalate PCT copolymer. However, the matrix component and the fiber component are not limited to the above-mentioned materials.

In the first step of the method according to the present invention wherein the matrix component and the fiber component (A and B components) are alternately arranged, further, the matrix component and the fiber component are desirably introduced at the weight ratio of 1:9 to 9:1, more desirably at the weight ratio of 7:3 to 3:7. When the matrix component and the fiber component are at the same time supplied into the extruder, the ratio of the fibers occupied in the matrix and the size of the fibers are determined in the final fiber-oriented composite material.

At this time, the ratio of the fibers occupied in the matrix is adjustable by means of an instrument for feeding a material like a gear pump, and for example, if the matrix component and the fiber component are supplied by means of the gear pump controllable precisely, the ratio of the fibers occupied in the matrix can be uniformly adjusted according to the revolutions per minute of the gear pump. The revolutions per minute of the gear pump are selected in a typical range thereof.

In the second step of the method according to the present invention, the melt of the matrix component and the fiber component supplied in the first step passes through a nozzle so that the fibers are distributed and arranged in the matrix in such a manner as to have desired fiber cross-sectional shape and arrangement.

In more detail, the nozzle is previously designed to have the desired cross-sectional shape, fiber denier, and filling ratio of the fibers, and accordingly, a passage mechanism of the nozzle has the desired cross-sectional shape and ratio of the fibers. Desirably, the cross-sectional shapes of the fibers are selected from the group consisting of a circle, a triangle, a square, or a combination thereof.

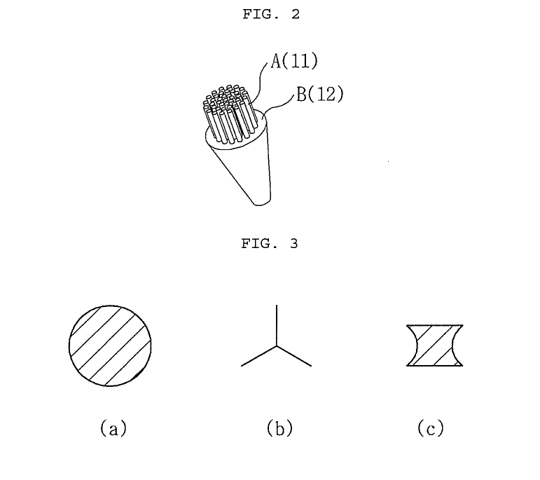

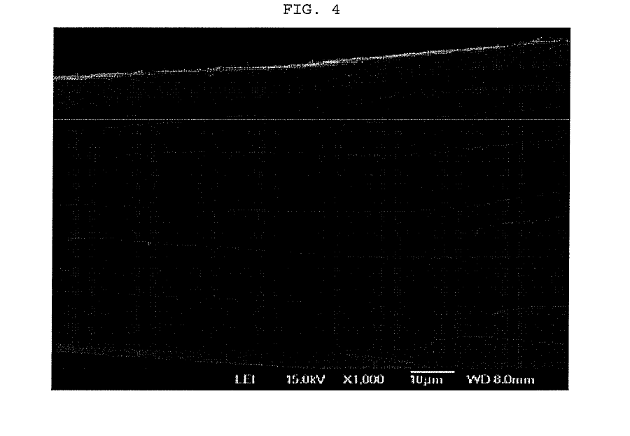

FIG. 2 is a perspective view showing the fibers distributed and arranged in the matrix in the interior of the passage connecting the nozzle and a die, at the second step in the method according to the present invention, and FIGS. 3a to 3c are cross-sectional views showing examples of the cross-sectional shapes of fibers designed through the nozzle in the method according to the present invention. Accordingly, the cross-sectional shapes of the fibers are obtained through the pattern of the circle a, the triangle b or the square c previously set on the nozzle.

Further, the determination in the cross-sectional shapes of the fibers in the matrix is dependent upon the difference of surface tension and viscosity between the matrix component and the fiber component.

In more detail, the difference of surface tension and viscosity between the matrix component and the fiber component prevents narrowing between fibers from occurring and allows the cross-sectional shapes of the fibers in the matrix in the final fibrous-oriented composite material to be adjustable.

As the difference of surface tension between the matrix component and the fiber component becomes increased, that is, the cross-sectional shapes of the fibers are close to the circle, and thus, the independent positions of the fibers can be occupied in the matrix. If the difference of surface tension and viscosity between the matrix component and the fiber component is greater than 20 dyne/m, desirably, the cross-sectional shapes of the fibers designed on the nozzle are kept on the final fibrous-oriented composite material, without having any change.

Contrarily, if the difference of surface tension between the matrix component and the fiber component becomes less than or almost equal to each other, the fiber component becomes mixed to the matrix component, and thus, the fibers do not have any independent positions and shapes in the matrix. That is, if the difference of surface tension between the matrix component and the fiber component is within 20 dyne/m so that they have similar surface tension to each other, the cross-sections of the fibers arranged in the matrix are expanded in a width direction upon molding the sheet according to the complex process of the matrix component and the fiber component, so that the fiber component is expanded together with the matrix component to allow the circular or polygonal sections to be extended in one axis direction.

Accordingly, the cross-sectional shapes of the fibers in the matrix in the final fibrous-oriented composite material can be determined even upon the physical properties between the matrix component and the fiber component.

According to the present invention, the sheet molding process in the third step is selected from the group consisting of inflation circular die extrusion, T-die extrusion, slit-die extrusion, or co-extrusion.

In more detail, when the extrudate is molded to the sheet through a die, the cross-sectional shapes, fiber deniers and filling ratios of the fibers in the matrix, as designed, are fixed to the sheet.

After the sheet is molded at the third step, the method according to the present invention further includes an elongation step.

The addition of the elongation step permits the fibers in the matrix to have a high degree of orientation or crystallinity and further provides optical birefringence for the fibers.

Furthermore, the present invention provides a fiber-oriented composite material manufactured using the method according to the present invention.

In more detail, the present invention provides a fiber-oriented composite material that is configured wherein fibers are arranged in-situ in the matrix, while being continuously arranged in the longitudinal direction thereof and discontinuously distributed and arranged in the perpendicular direction to the longitudinal direction thereof.

In case of the cross-sections of the fiber-oriented composite materials manufactured according to first to third embodiments of the present invention, the fibers are discontinuously arranged in the matrix and have one-directional surface, so that it is checked that the fibers are continuously arranged in one direction in the matrix.

According to the present invention, the fibers in the matrix in the fiber-oriented composite material are distributed and arranged desirably in the range of 10 to 90 weight %, more desirably in the range of 10 to 90 weight %. At this time, if the fibers are less than 10 weight %, the effects of the fibers in the matrix become weak, and contrarily, if they are greater than 90 weight %, the effects of the matrix component cannot be expected.

According to the present invention, the cross-sectional shapes of the fibers in the matrix are circular, but of course, they may be selected from the group consisting of a polygon such as a triangle, a square, or a combination thereof.

At this time, from the observation of the circular sectional shapes of the fibers in the matrix, it can be appreciated that the difference of surface tension between the matrix component and the fiber component is greater than 20 dyne/m.

On the other hand, FIG. 4 is a photograph showing another sectional shape of a fiber-oriented composite material manufactured according to the present invention, wherein the fiber-oriented composite material is configured to have the fibers in the matrix having the circular or polygonal sectional shapes in such a manner as to be extended drastically in one axis direction. At this time, the fibers in the matrix have the circular or polygonal sectional shapes and are extended drastically in one axis direction, which is observed when the difference of surface tension between the matrix component and the fiber component is less than 20 dyne/m, that is, when they have similar surface tension to each other.

The present invention provides a reflective composite sheet that is made of a fiber-oriented composite material configured wherein fibers are arranged in-situ in the matrix, while a refractive index in the longitudinal direction of the matrix is being designed greater than a refractive index in the longitudinal direction of the fibers.

Further, a refractive index in the vertical direction to the longitudinal direction of the fibers in the fiber-oriented composite material is greater than or equal to a refractive index in the vertical direction to the longitudinal direction of the matrix.

More desirably, the reflective composite sheet is made of a multi-layer fiber-oriented composite material having the fibers arranged repeatedly in the matrix in such a manner as to have high-low-high refractive indices in the longitudinal direction thereof.

According to the reflective composite sheet made of the multi-layer fiber-oriented composite material, desirably, a difference between the refractive index in the longitudinal direction of the matrix and that in the longitudinal direction of the fibers is greater than 0.01, and accordingly, high reflection is induced to the longitudinal direction of the fibers, while low reflection is being induced to the vertical direction to the longitudinal direction of the fibers, so that one polarized light is reflected, and the other polarized light is transmitted.

Accordingly, the multi-layer fiber-oriented composite material has at least two or more layers, desirably ten or more layers, or 50 or more layers from the simulation estimation result wherein a maximum value of the reflectance is obtained.

According to the fiber-oriented composite material of the refractive composite sheet, the fibers in the matrix have the cross-sectional shapes selected from the group consisting of a circle including a sphere and an oval, a polygon including a triangle or a square, or a combination thereof.

More preferably, the cross-sectional shapes of the fibers have a rectangular parallelepiped having a long axis longer than a short axis, as a continuously small and large shape, and in this case, the reflection polarization efficiency can be improved.

Like this, the cross-sectional shapes of the fibers give influences on the reflectance, and therefore, if the distance between the fibers is long or the cross-sectional shapes of the fibers are continuous, without having discontinuity, the reflectance and the polarization efficiency are increased.

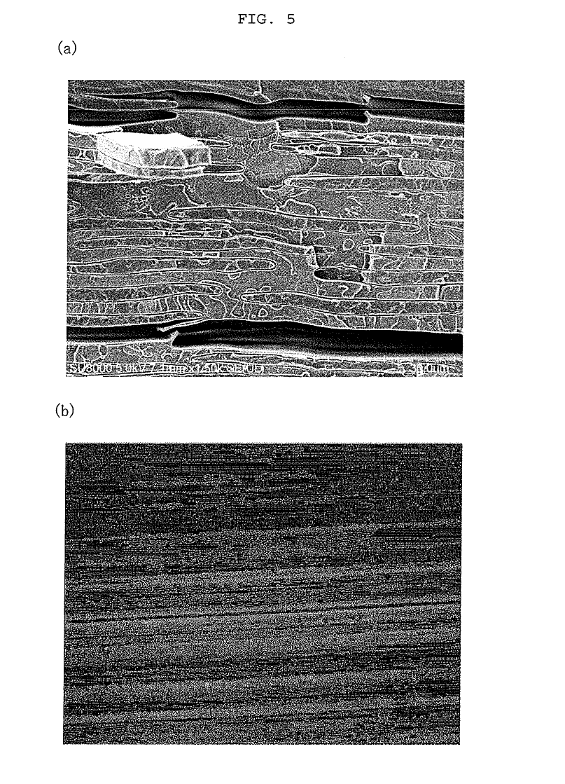

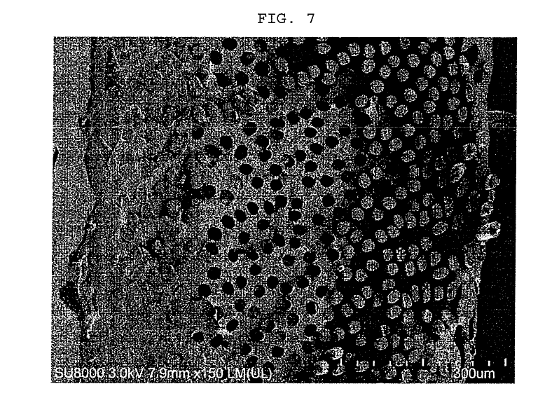

FIG. 5 is photograph showing the cross-section and surface of a fiber-oriented composite material of a reflective composite sheet manufactured according to Example 6, wherein the fibers have the cross-sectional shapes of the rectangular parallelepipeds extended in one axis direction from the circular or polygonal sections, and the fiber-oriented composite material has one directional surface. FIG. 7 is a photograph showing the oval sections of the fiber component of the fiber-oriented composite material of a reflective composite sheet manufactured according to Example 9, wherein the fibers in the matrix are continuously arranged in the longitudinal direction of the sheet and discontinuously arranged in the perpendicular direction to the longitudinal direction of the sheet.

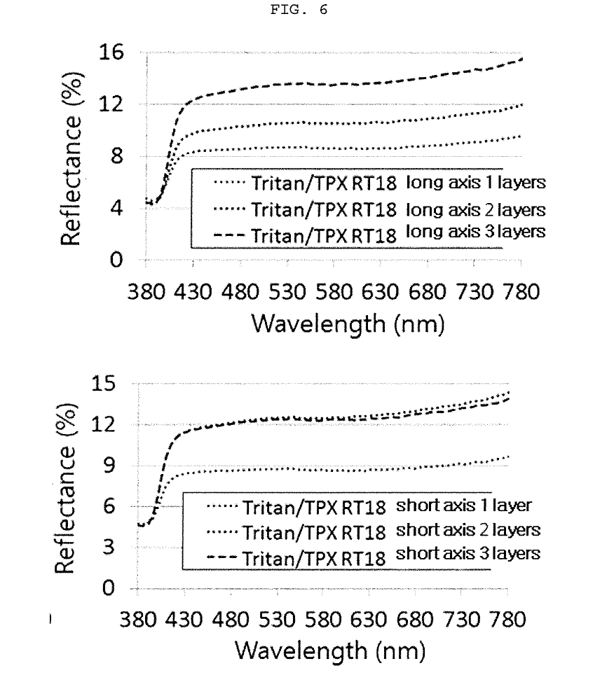

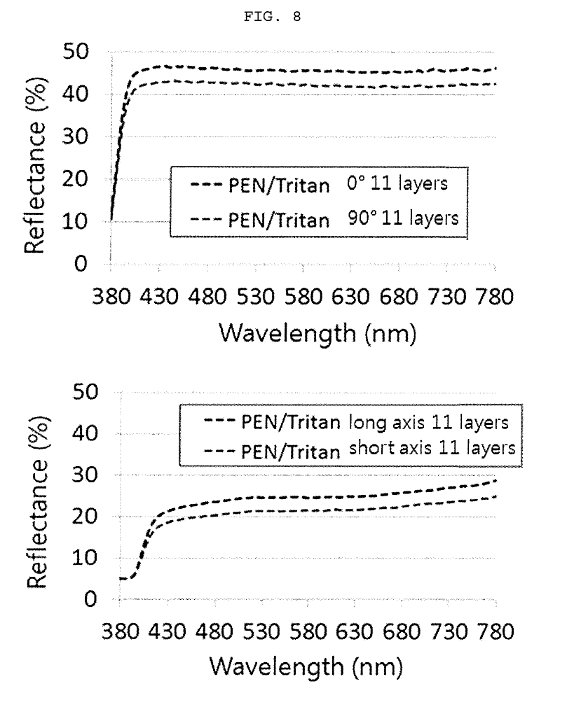

FIG. 6 and FIG. 8 are graphs showing reflectance measurement results of the reflective composite sheet according to the sections of the fiber-oriented composite material, and particularly, the reflective composite sheet made of the multi-layer fiber-oriented composite material shows high reflectance through the increment of the layers.

According to the fiber-oriented composite material of the reflective composite sheet, the fibers in the matrix are distributed and arranged desirably in the range of 10 to 90 weight %, more desirably in the range of 10 to 90 weight %. At this time, if the fibers are less than 10 weight %, the distribution of the fibers in the matrix becomes extremely reduced and the reflectance is decreased due to repeated boundary surfaces between the matrix and the fibers, thus causing dispersing and scattering. Contrarily, if they are greater than 90 weight %, the matrix cannot be formed well to cause the fibers to stick to each other.

Accordingly, the fibers of the fiber-oriented composite material of the reflective composite sheet can be controlled in their distance. Desirably, the distance between the fibers of the fiber-oriented composite material is 200 nm or under so as to prevent incident light from being transmitted (leaking).

According to the present invention, the matrix of the fiber-oriented composite material is made of an optically isotropic or optically anisotropic polymer resin, and also, the fibers are made of an optically isotropic or optically anisotropic polymer resin.

At this time, if the matrix is made of the optically anisotropic polymer resin, the fibers are desirably made of the optically isotropic polymer resin, and contrarily, if the matrix is made of the optically isotropic polymer resin, the fibers are desirably made of the optically anisotropic polymer resin, so that the refractive index of the fibers in the longitudinal direction thereof can be controlled.

In more detail, if most of polymer resin is elongated in the longitudinal direction after molded to the sheet, the refractive index in the longitudinal direction thereof is increased, but the refractive index in the vertical direction to the longitudinal direction thereof is decreased.

If the fibers are made of the optically isotropic polymer resin and the matrix is made of the optically anisotropic polymer resin, the matrix is elongated in the longitudinal direction thereof, so that the refractive index of the fibers in the longitudinal direction thereof can be less than that of the matrix in the longitudinal direction thereof.

Further, if the fibers are made of the optically anisotropic polymer resin and the matrix is made of the optically isotropic polymer resin, the fibers are elongated in the longitudinal direction thereof, so that the refractive index of the fibers in the vertical direction to the longitudinal direction thereof can be greater than or equal to that of the matrix in the vertical direction thereof.

However, if the refractive index of the fibers in the longitudinal direction thereof is less than that of the matrix in the longitudinal direction, both of the matrix and the fibers are made of an optically anisotropic polymer resin or an optically isotropic polymer resin.

Accordingly, the fiber-oriented composite material is controllable by the refractive indices of the materials selected as the matrix and the fibers.

When elongated, generally, the optically anisotropic polymer resin is increased in refractive index, and at this time, the refractive index of the optically anisotropic polymer resin is greater than 1.40. For example, poly 1,4-cyclohexanedimethylene terephthalate PCT has a refractive index of 1.55, polycyclohexylenedimethylene terephthalate PCTG has a refractive index of 1.56, polyethylene terephthalate glycol-modified PETG has a refractive index of 1.57, polyethylene therephthalate PET has a refractive index of 1.575, pentaerythritol tetranitrate PETN has a refractive index of 1.583, polystyrene PS has a refractive index of 1.59, and polyethylenenaphthalate PEN has a refractive index of 1.65. However, the refractive indices are not limited to those mentioned above.

Contrarily, there is polymethyl methacrylate PMMA having a refractive index of 1.49, as the optically anisotropic polymer resin increased in refractive index through elongation.

Further, examples of the optically isotropic polymer resin having small change in refractive index include polymethylpentene TPX RT 18 having a refractive index of 1.46, cyclo-olefin polymer COP having a refractive index of 1.53, and fluorine based polyester FBP-HX, Osaka Gas Chemicals, JAPAN, OKP850 having a refractive index of 1.65, but if they are known as the optically isotropic polymer resin, they may be used without any limitation. Like this, the fibers and the matrix are selected from the materials having the above refractive indices and arranged through various combinations of the refractive indexes.

The present invention provides a method for manufacturing a reflective composite sheet made of a fiber-oriented composite material. In more detail, the method for manufacturing a reflective composite sheet includes the steps of: extruding a matrix component and a fiber component through a bi-composite spinneret, at the same time; distributing and arranging fibers in a matrix in the longitudinal direction thereof; and molding the extrudate of the fibers in the matrix to a sheet, wherein through a take-up process of the sheet molding, the refractive index in the longitudinal direction of the matrix is greater than that in the longitudinal direction of the fibers, and the refractive index in the vertical direction to the longitudinal direction of the fibers is greater than or equal to the refractive index in the vertical direction to the longitudinal direction of the matrix.

More desirably, the reflective composite sheet is made of a multi-layer fiber-oriented composite material having the fibers arranged repeatedly in the matrix in such a manner as to have high-low-high refractive indices in the longitudinal direction thereof.

According to the refractive composite sheet, desirably, a difference between the refractive index in the longitudinal direction of the matrix and that of the fibers is greater than 0.01.

The first to third steps of the method for manufacturing the reflective composite sheet are the same as those of the method for the fiber-oriented composite material, and for the brevity of the description, an explanation on the sheet molding process at the third step will be in detail given below.

According to the present invention, the sheet molding process in the third step of the method for manufacturing the reflective composite sheet is selected from the group consisting of inflation circular die extrusion, T-die extrusion, slit-die extrusion, or co-extrusion.

In more detail, when the extrudate is molded to the sheet through a die, the cross-sectional shapes, fiber deniers and filling ratios of the fibers in the matrix, as designed, are fixed to the sheet. The fibers of the present invention are observed to have the sections extended in one axis direction from the circular or polygonal structures through the slit-die extrusion.

At this time, in the sheet molding process the extrudate passes through a plurality of take-up rollers, and if the speeds of the take-up rollers by step are changed, the sheet elongation effects can be obtained, thus controlling the refractive indices of the matrix and the fibers.

In more detail, when the extrudate passes through a first take-up roller, a second take-up roller and a third take-up roller and molded to the sheet, the take-up speeds by step may be varied. That is, the first take-up roller has a low take-up speed, and the second and third take-up rollers have a take-up speed in the range of 0 to 30 m/min. At this time, the larger the changes of the take-up speeds by step are, the bigger the elongation effects are, thus allowing the refractive indices of the matrix and the fibers to be in a desired range.

After the sheet is molded at the third step, the method for manufacturing the reflective composite sheet for according to the present invention further includes an elongation step.

The addition of the elongation step permits the fibers in the matrix to have a high degree of orientation or crystallinity and especially provides optical birefringence for the fibers.

If the fibers are made of an optically isotropic polymer resin and the matrix is made of an optically anisotropic polymer resin, the matrix is elongated in the longitudinal direction thereof, so that the refractive index of the matrix in the longitudinal direction thereof can be greater than that of the fibers in the longitudinal direction thereof. Through the control of the refractive indexes, the multi-layer fiber-oriented composite material has the fibers arranged repeatedly in the matrix in such a manner as to have high-low-high refractive indices in the longitudinal direction thereof, thus enhancing the reflection polarization efficiencies.

Further, if the fibers are made of an optically anisotropic polymer resin and the matrix is made of an optically isotropic polymer resin, the fibers are elongated in the longitudinal direction thereof, so that the refractive index of the fibers in the vertical direction to the longitudinal direction thereof can be greater than or equal to that of the matrix in the vertical direction thereof.

Through the elongation process, high reflection is induced to the longitudinal direction of the fibers, while low reflection is being induced to the vertical direction to the longitudinal direction of the fibers, so that horizontally polarized light is reflected, and the other vertically polarized light is transmitted.

In the method for manufacturing the reflective composite sheet, the fiber cross-sectional shape, fiber thickness and filling ratio of the fibers of the fiber-oriented composite material are controlled, while they are being arranged in one direction, and further, the refractive indices between the fibers and the matrix can be controlled.

FIGS. 9 to 11 show simulation estimation results of the optimum reflectance of the reflective composite sheet made of the fiber-oriented composite material, wherein when the refractive index of the fibers in the longitudinal direction thereof and the refractive index of the matrix in the longitudinal direction thereof are repeatedly arranged to have high, low and high (1.65, 1.55, and 1.65) refractive indexes, optimum reflectance is suggested, and particularly, in case of the reflective composite sheet made of a multi-layer fiber-oriented composite material, the reflectance close to 100% can be obtained at the maximum 48-layer fiber component structure.

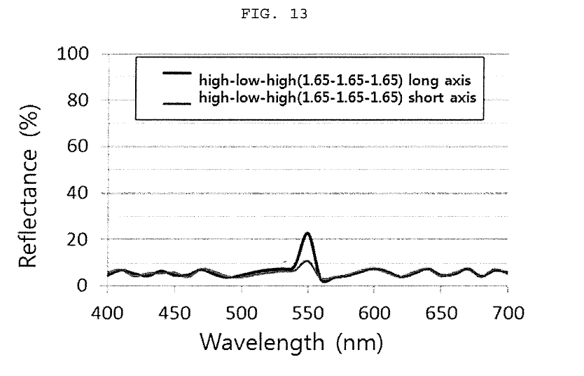

FIGS. 12 and 13 show the simulation estimation results of reflectance of the reflective composite sheet made of the fiber-oriented composite material wherein the fibers are embedded in the longitudinal direction in the matrix, wherein if a refractive index difference between the longitudinal direction of the fibers and the longitudinal direction of the matrix is set to 0.03, excellent reflection polarization effects can be obtained.

Accordingly, the reflective composite sheet according to the present invention is replaceable with a conventional Dual Brightness Enhancement Film DBEF of 3M and also used as other optical films.

Furthermore, the present invention provides a backlight unit for a liquid crystal display using the reflective composite sheet made of the multi-layer fiber-oriented composite material.

Hereinafter, the present invention will be in detail described with reference to various embodiments.

The embodiments are suggested just to explain the present invention, but do not limit the scope of the present invention.

### A. Manufacturing Fiber-Oriented Composite Material

### Example 1

A matrix component, poly-4-methylene pentene PMP (TPX RT18 which is a trademark of Mitsui Chemicals) and a fiber component, polyethylene naphthalate PEN (NOPLA which is a trademark of Kolon Plastics) were melted at the weight ratio of 7:3. At this time, the melting temperature of the matrix component PMP was 232° C. and that of the fiber component PEN was 280° C., so that a difference between the melting temperatures of the two components was 48° C.

Further, the surface tension of the matrix component PMP was 24 dyne/m, and that of the fiber component PEN was 47 dyne/m, so that a difference between the surface tensions of the two components was 23 dyne/m.

The matrix component and the fiber component were quantitatively adjusted and supplied by means of a gear pump in such a manner as to be alternately arranged and flowed into an extruder kept to a temperature of 260 to 290° C.

The melt of the matrix component and the fiber component in the extruder passed through a nozzle having a circular section and 3808 holes formed thereon, so that the fibers were distributed and arranged in the matrix. At this time, the nozzle had a temperature of 295 to 300° C.

The matrix component and the fiber component were combined in the melt inlet of a coat-hanger die, and then passed through melt-distribution manifold of the coat-hanger die kept to 300° C. and molded to a sheet, and next, the sheet was dried, thus the fiber-oriented composite material was fabricated.

### Example 2

The fiber-oriented composite material was fabricated in the same manner as in Example 1, except that the matrix component PMP and the fiber component PEN were at the same time introduced into an extruder at the weight ratio of 8:2.

### Example 3

The fiber-oriented composite material was fabricated in the same manner as in Example 1, except that the matrix component PMP and the fiber component PEN were at the same time introduced into an extruder at the weight ratio of 9:1.

### Example 4

The fiber-oriented composite material was fabricated in the same manner as in Example 1, except that a matrix component, polycyclohexane dimethylterephthalate copolymer PCT (Tritan TX2001 which is a trademark of Eastman company) and a fiber component, polyethylene naphthalate PEN (NOPLA which is a trademark of Kolon Plastics) were used.

At this time, the melting temperature of the matrix component PCT was 250° C. and that of the fiber component PEN was 280° C., so that a difference between the melting temperatures of the two components was 30° C. Further, the surface tension of the matrix component PCT was 45 dyne/m, and that of the fiber component PEN was 47 dyne/m, so that a surface tension difference between the two components was 2 dyne/m.

### Example 5

The fiber-oriented composite material was fabricated in the same manner as in Example 5, except that after the sheet was formed, an elongation process was further conducted wherein the sheet was elongated by 3.5 times in a longitudinal direction and next elongated by 3.5 times in a transverse direction.

### B. Manufacturing Reflective Composite Sheet Made of Fiber-Oriented Composite Material

### Example 6

A matrix component, poly 1,4-cyclohexanedimethylene terephthalate PCT (TRITAN, 1.55) and a fiber component, polymethylpentene polymer (TPX RT18. 1.46) were melted at the weight ratio of 7:3 and supplied by means of a gear pump in such a manner as to be alternately arranged and flowed into an extruder kept to a temperature of 260 to 290° C.

The melt of the matrix component and the fiber component in the extruder passed through a nozzle having a circular section and 3808 holes formed thereon, so that the fibers were distributed and arranged in the matrix. At this time, the nozzle had a temperature of 295 to 300° C.

The polymers passing through the nozzle extruded through a slit die kept to 300° C., contacted with the surface of a cooling roll, solidified, and molded to a sheet through continuous take-up processes. At this time, the extrudate passed sequentially through take-up rollers at a first roller take-up speed of 3 m/min, a second roller take-up speed of 29 m/min and a third roller take-up speed of 29 m/min, so that the refractive index of the longitudinal direction of the fibers was less than that of the longitudinal direction of the matrix. Next, the sheet was dried, thus manufacturing the reflective composite sheet made of the fiber-oriented composite material. At this time, the fiber-oriented composite material has a structure having the fibers arranged repeatedly in such a manner as to have high-low-high refractive indices in the longitudinal direction of the fibers and in the vertical direction to the longitudinal direction thereof.

### Example 7-8

The reflective composite sheet was fabricated in the same manner as in Example 6, except that the fiber-oriented composite material has a multi-layered structure having the fibers arranged repeatedly in the matrix that is two layers and three layers respectively.

### Example 9

The reflective composite sheet was fabricated in the same manner as in Example 6, except that the fiber-oriented composite material has a multi-layered structure having 11 layers was carried out in the same manner as in Example 1, except that a matrix component, polyethylene naphthalate PEN (NOPLA, 1.65 which is a trademark of Kolon Plastics) and a fiber component, triphenylene methane (TRITAN, 1.55) were at the same time supplied at the weight ratio of 8:2 and a T-die having an angle of 90° was used.

### Example 10

Upon manufacturing the fiber-oriented composite material in Example 9, if the matrix was made of an optically anisotropic polymer resin and the fibers were made of an optically isotropic polymer resin, the matrix was elongated in the longitudinal direction thereof, so that the refractive index of the matrix in the longitudinal direction thereof was greater than that of the fibers in the longitudinal direction thereof, thus manufacturing the reflective composite sheet made of the multi-layer fiber-oriented composite material having 8 layers and having a structure wherein high-low-high refractive indexes are repeatedly arranged in the longitudinal direction of the fibers from the longitudinal direction of the matrix.

At this time, the refractive index of the fibers in the vertical direction to the longitudinal direction thereof was greater than and equal to that of the matrix in the vertical direction thereof, so that low-high-low refractive indexes are repeatedly arranged in the vertical direction of the fibers.

### Example 11

The reflective composite sheet was fabricated in the same manner as in Example 6, except in the fiber-oriented composite material was conducted by the take-up process of Example 6, the extrudate passed sequentially through take-up rollers at a first roller take-up speed of 3 m/min, a second roller take-up speed of 4 m/min and a third roller take-up speed of 4 m/min.

### Example 12

The reflective composite sheet was fabricated in the same manner as in Example 6, except in the fiber-oriented composite material was conducted by the take-up process of Example 6, the extrudate passed sequentially through take-up rollers at a first roller take-up speed of 3 m/min, a second roller take-up speed of 6 m/min and a third roller take-up speed of 29 m/min.

### Example 13

The reflective composite sheet was fabricated in the same manner as in Example 6, except in the fiber-oriented composite material was conducted by the extrudate passing through the nozzle in Example 6 was taken up via a slit die kept to 300° C., rapidly cooled and hardened by means of air blowing, and elongated by means of high temperature and high pressure air in longitudinal and traverse directions.

### Experiment 1

### Surface Observation of Fiber-Oriented Composite Material According to Ratios of Components

The ratio of the matrix component and the fiber component and the occupied ratio of the fibers in Example 1 to 3 were listed in Table 1, and the manufactured fiber-oriented composite materials were magnified 150 times in cross-section and 50 times in surface and observed by means of a scanning electron microscope.

As a result, from the cross-sections of the fiber-oriented composite materials manufactured according to Example 1 to 3, it was checked that the fibers in the matrix were discontinuously distributed and arranged, and from the observation of the surfaces thereof, it was checked that the fibers were continuously aligned in one direction.

Further, it was checked that the cross-sections of the fibers distributed in the matrix were circular.

TABLE 1

| Division | Example 1 | Example 2 | Example 3 |
|---|---|---|---|
| Ratio of Matrix Component (PMP) | 0.7 | 0.8 | 0.9 |
| Ratio of Fiber Component (PEN) | 0.3 | 0.2 | 0.1 |
| Occupied Ratio of Fibers in | 30 | 20 | 10 |
| Fiber-oriented Composite Material | | | |

### Experiment 2

### Surface Observation of Fiber-Oriented Composite Material According to Changes of Components

The fiber-oriented composite material manufactured through the matrix component (PCT) and the fiber component (PEN) according to Example 5 were magnified 150 times in cross-section and observed by means of a scanning electron microscope.

As a result, as shown in FIG. 4, from the cross-section of the fiber-oriented composite material manufactured according to Example 4, it was checked that the cross-sectional shapes of the fibers in the matrix were extended further to one axis direction than the circular sectional shapes of the fibers observed from the sections of the fiber-oriented composite materials manufactured according to Example 1 to 3.

### Experiment 3

### Reflectance Measurement 1

The reflectance of the reflective composite sheet made of the fiber-oriented composite materials manufactured according to Example 6 to 8 was observed wherein a long axis was set when the polarized direction of the incident light was parallel to the direction of the fibers and a short axis was set when the polarized direction of the incident light was vertical to the direction of the fibers.

FIG. 6 shows the reflectance measurement result of the reflective composite sheet manufactured according to Example 6 to 8, wherein it was checked from the reflectance data on the long and short axes that as the layers were increased, the reflectance was increased.

At this time, after a sample was manufactured to have a structure wherein high-low-high refractive indices are repeated in the longitudinal directions of the fibers and in the vertical directions to the longitudinal directions thereof, it was checked that the reflectance was increased according to the increment of the layers.

### Experiment 4

### Reflectance Measurement 2

The reflectance of the reflective composite sheet made of the 11-layer fiber-oriented composite material manufactured according to Example 9 was observed with respect to incident light of 0° and 90° and the directions of long and short axes.

As shown in FIG. 8, the reflectance of the reflective composite sheet made of the 11-layer fiber-oriented composite material with respect to the unpolarized incident light was remarkably increased when compared with the reflectance of the reflective composite sheet with respect to the directions of long and short axes.

### Experiment 5

### Reflectance Measurement 3

The reflectance of the reflective composite sheet made of the 8-layer fiber-oriented composite material manufactured according to Example 10 was observed with respect to the directions of long and short axes.

FIG. 9 shows the reflectance measurement result of the reflective composite sheet made of the multi-layer fiber-oriented composite material with respect to the directions of long and short axes, wherein different reflectance was obtained in the directions of long (parallel) and short (perpendicular) axes, and the incident light was high reflected in the longitudinal direction of the fibers, thus obtaining remarkably high reflectance.

### Experiment 6

### Simulation Estimation 1

Media having refractive indices of 1.65 (which is standard of PEN) and 1.55 (which is standard of TRITAN2001) were set as repeating units through MATLAB programming, and a sample of a multi-layer fiber-oriented composite material having the combination of 1.65-1.55-1.65 (High-Low-High) refractive indices was manufactured, thus measuring the reflectance of the sample.

At this time, λ was set with respect to a wavelength of 550 nm on which a human being feels maximum visibility, and respective layer thicknesses were set increased to the same ratio as each other.

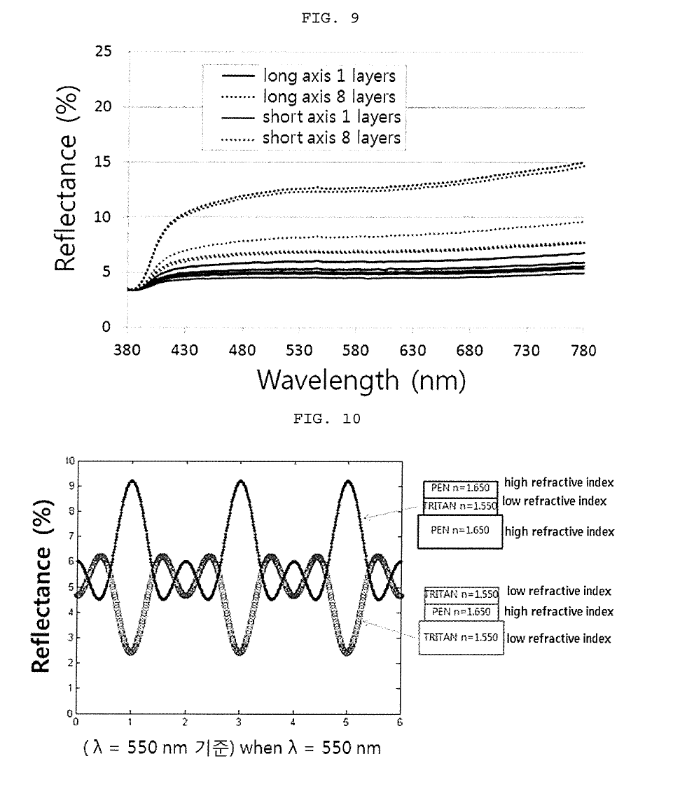

FIG. 10 shows the simulation estimation result of the optimum reflectance of the reflective composite sheet made of the multi-layer fiber-oriented composite material, wherein when the fibers in the longitudinal directions thereof are repeatedly arranged in the combination of high, low and high (1.65, 1.55, and 1.65) refractive indexes. If the respective layer thicknesses satisfied odd number times of λ/4, it was checked that maximum reflectance of greater than 9% was obtained.

Contrarily, it was checked that minimum reflectance of about 2% was obtained from the combination of low, high and low (1.55, 1.65, and 1.55) refractive indexes.

The reflectance of the sample having the multi-layer fiber-oriented composite material was calculated through the MATLAB programming.

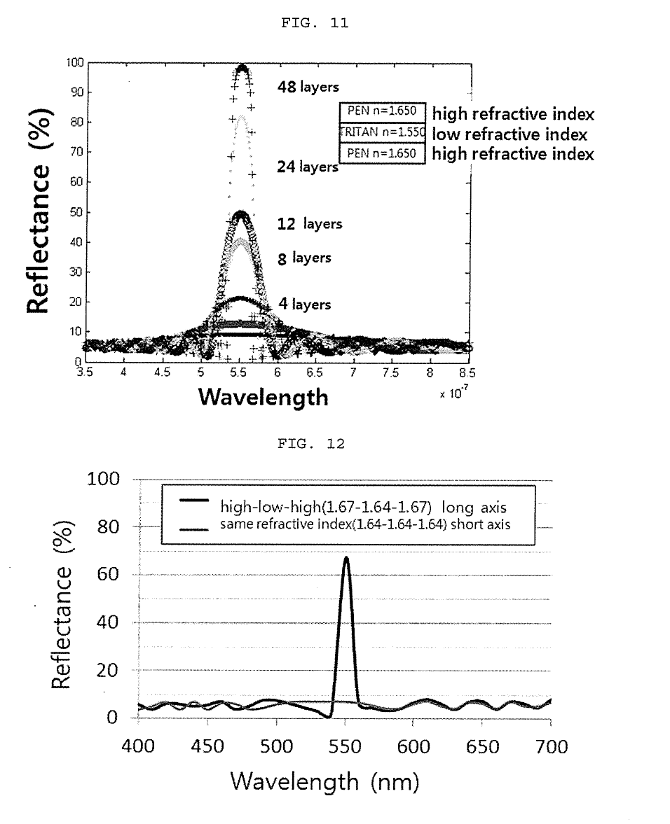

The calculation result was shown in FIG. 11, and accordingly, it was checked that from the 12-layer fiber-oriented composite material having the fiber component arrangement structure of the combination of 1.65, 1.55, and 1.65 refractive indexes, reflectance of 50% was obtained, from the 24-layer fiber-oriented composite material, reflectance of 80% was obtained, and from the 48-layer fiber-oriented composite material, reflectance close to 100% was obtained.

### Experiment 7

### Simulation Estimation 2

Reflectance of the reflective composite sheet made of the fiber-oriented composite material having the fibers embedded in the matrix was measured through programming (FDTD solution made by Lumerical), wherein the refractive index of the matrix in the longitudinal direction thereof was 1.67 and the refractive indices of the fibers in the longitudinal directions thereof were 1.64. The distance between the fibers of the fiber-oriented composite material was 200 nm, and the thickness of the matrix and the fibers was 82.33 nm. Under the conditions, the reflectance of the reflective composite sheet was measured with respect to the directions of long and short axes.

FIG. 12 shows the simulation estimation result of the optimum reflectance of the reflective composite sheet made of the multi-layer fiber-oriented composite material in the directions of long and short axes, wherein the difference between the refractive indices of the fibers in the longitudinal directions thereof and the matrix in the longitudinal direction thereof is 0.03. It was checked that the reflectance of the reflective composite sheet made of the 50-layer fiber-oriented composite material in the direction of the long axis was 67%.

Contrarily, FIG. 13 shows the simulation estimation result of the optimum reflectance of the reflective composite sheet made of the multi-layer fiber-oriented composite material in the directions of long and short axes, wherein the difference between the refractive indices of the fibers in the longitudinal directions thereof and the matrix in the longitudinal direction thereof is 0.01. It was checked that if sufficient elongation is not conducted, the reflectance of the reflective composite sheet in the direction of the long axis was 22.7% and the reflectance thereof in the direction of the short axis was 10.8%.

It can be appreciated from the above-mentioned simulation estimation results that the difference between the refractive indices of the fibers in the longitudinal directions thereof and the matrix in the longitudinal direction thereof is greater than at least 0.01.

As mentioned above, there is provided the method for manufacturing a fiber-oriented composite material according to the present invention, wherein the matrix component and fiber component made of the thermoplastic materials are at the same time extruded and then pass through the nozzle predetermined to have a fiber cross-sectional shape, fiber thickness and filling ratio of the fibers, so that the fibers are arranged in-situ in the matrix in one direction, while the cross-sectional shape, fiber thickness and filling ratio of the fibers in the matrix are being controlled. Through the manufacturing method of in-situ process, the composite material is obtained, thus reducing the number of processes, making the thicknesses of the fibers and the matrix to be thin, effectively controlling the filling, distribution or reinforcement of the fibers in the matrix, and achieving the high degree of density of fibers in the matrix.

Accordingly, the fiber-oriented composite material made using the method is configured wherein the fibers are arranged in-situ in the matrix in one direction, thus reinforcing the strength and elasticity thereof and expecting the extension of the applicable fields according to the optical birefringence of the fibers.

Furthermore, the present invention provides the reflective composite sheet made of the fiber-oriented composite material to which polarized light is induced, wherein high reflection is induced to the longitudinal direction of the fibers and low reflection is induced to the vertical direction to the longitudinal direction of the fibers, so that horizontally polarized light is reflected, and the other vertically polarized light is transmitted.

Additionally, the present invention provides the method for manufacturing the reflective composite sheet wherein the fibers are prearranged in the matrix in one direction, while the cross-sectional shape, fiber thickness and filling ratio of the fibers in the matrix are being controlled, so that specific refractive index conditions are controlled in process, thus providing excellent reflective polarization.

Furthermore, the present invention provides the backlight unit for a liquid crystal display that is improved in physical properties, through the reflective composite sheet having excellent reflective polarization.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method for manufacturing a fiber-oriented composite material comprising the steps of:
a) feeding a matrix component and a fiber component into each extruder, at the same time;
b) passing the melt of the supplied matrix component and fiber component through a nozzle predetermined to have a fiber cross-sectional shape, fiber thickness and filling ratio of fibers, and distributing and arranging the fibers in a matrix in such desired shape and arrangement; and
c) molding the fibers distributed and arranged in the matrix to a sheet, so that the fibers are aligned in the matrix in one direction in-situ manner.

2. The method according to claim 1, wherein a difference of melting temperature between the matrix component and the fiber component is greater than 20° C.

3. The method according to claim 1, wherein a surface tension difference between the matrix component and the fiber component is greater than 20 dyne/m.

4. The method according to claim 1, wherein at the step (a) the matrix component and the fiber component are supplied at the weight ratio of 1:9 to 9:1.

5. The method according to claim 1, wherein at the step (b) the fibers in the matrix have the cross-sectional shapes selected from the group consisting of a circle, a polygon and a combination thereof.

6. The method according to claim 1, wherein at the step (c) the molding is conducted by any one selected from the group consisting of inflation circular die extrusion, T-die extrusion, slit-die extrusion and co-extrusion.

7. The method according to claim 1, further comprising the step of elongating the sheet after the step (c).

8. A fiber-oriented composite material comprising fibers embedded within a matrix aligned continuously in the longitudinal direction thereof and arranged discontinuously in the perpendicular direction to the longitudinal direction thereof.

9. The fiber-oriented composite material according to claim 8, wherein if a surface tension difference between the matrix component and the fiber component is greater than 20 dyne/m, the fibers embedded within the matrix have the cross-sectional shapes selected from the group consisting of a circle, a polygon and a combination thereof.

10. The fiber-oriented composite material according to claim 8, wherein if a surface tension difference between the matrix component and the fiber component is less than 20 dyne/m, the fibers embedded within the matrix have the cross-sectional shapes selected from the group consisting of a circle, a polygon and a combination thereof in such a manner as to be extended in one axis direction thereof.

11. A reflective composite sheet having a fiber-oriented composite material according to claim 8, wherein at the fiber-oriented composite material, refractive index of the matrix in the longitudinal direction thereof is greater than the refractive index of the fibers in the longitudinal direction thereof.

12. The reflective composite sheet according to claim 11, wherein the fiber-oriented composite material has a multi-layered structure having the fibers arranged repeatedly in the matrix in such a manner as to have high-low-high refractive indices in the longitudinal direction thereof.

13. The reflective composite sheet according to claim 11, wherein a difference between the refractive index in the longitudinal direction of the matrix and the refractive index in the longitudinal direction of the fibers is greater than 0.01.

14. The reflective composite sheet according to claim 11, wherein the fibers in the matrix are distributed and arranged in the range of 10 to 90 weight %.

15. A method for manufacturing a reflective composite sheet made of a fiber-oriented composite material, comprising the steps of:
a) extruding a matrix component and a fiber component through a bi-composite spinneret, at the same time;
b) distributing and arranging fibers in a matrix; and
c) molding the extrudate of the fibers distributed and arranged in the matrix to a sheet,
wherein the reflective composite sheet is made of the fiber-oriented composite material wherein through a take-up process at the step (c), the refractive index of the fibers in the longitudinal direction thereof is less than the refractive index of the matrix in the longitudinal direction thereof, and the refractive index in the vertical direction to the longitudinal direction of the fibers is greater than or equal to the refractive index in the vertical direction of the matrix, thus inducing polarized light.

16. The method according to claim 15, wherein the fiber-oriented composite material has a multi-layered structure consisting of system of a high-polymer matrix and low-fibers in such a manner as to have arranged repeatedly high-low-high refractive indices between from the longitudinal direction of the matrix to that of the fibers.

17. The method according to claim 15, wherein the matrix component and the fiber component are extruded simultaneously at the weight ratio of 1:9 to 9:1.

18. The method according to claim 15, further comprising the step of elongating the sheet after the step (c), so as to control the refractive indices between the components of the fiber-oriented composite material.

19. A backlight unit for a liquid crystal display using the reflective composite sheet according to claim 11.
